(19) United States
(12) Patent Application Publication
(10) Pub. No.: US 2015/0375492 A1
(43) Pub. Date: Dec. 31, 2015

(54) APPARATUS AND METHODS OF FORMING FLEXIBLE GLASS LAMINATES USING ELECTROSTATIC PINNING

(71) Applicants: Donald Orrin BIGELOW, Honeoye Falls,, NY (US); Chester Hann Huei CHANG, Painted Post,, NY (US); Gary Edward MERZ, Rochester,, NY (US); John Earl TOSCH, Wellsburg,, NY (US); CORNING INCORPORATED, Corning,, NY (US)

(72) Inventors: Donald Orrin Bigelow, Honeoye Falls, NY (US); Chester Hann Huei Chang, Painted Post, NY (US); Gary Edward Merz, Rochester, NY (US); John Earl Tosch, Wellsburg, NY (US)

(21) Appl. No.: 14/766,350

(22) PCT Filed: Feb. 4, 2014
(86) PCT No.: PCT/US14/14603

§ 371 Date: Aug. 6, 2015

Related U.S. Application Data
(60) Provisional application No. 61/762,001, filed on Feb. 7, 2013.

(51) Int. Cl. B32B 38/00; B32B 37/20; B32B 3/16; B32B 17/06; B32B 7/12; B32B 37/12; B32B 37/00

(52) U.S. Cl. CPC B32B 38/0008; B32B 37/1207; B32B 37/20; B32B 38/0012; B32B 37/0046; B32B 17/06; B32B 7/12; B32B 3/16; B32B 2307/546; B32B 2457/208

(57) ABSTRACT

A method of forming a flexible glass laminate is provided. The method includes charging a flexible glass substrate with an electrostatic charge and charging a laminate substrate with an electrostatic charge that has a polarity opposite a polarity of the charge on the flexible glass substrate. The flexible glass substrate and the laminate substrate are brought together, with an adhesive therebetween, thereby creating an adhesive bond and an electrostatic bond between the flexible glass substrate and the laminate substrate.

This application claims the benefit of priority under 35 U.S.C. §119 of U.S. Provisional Application Ser. No. 61/762,001 filed on Feb. 7, 2013 the content of which is relied upon and incorporated herein by reference in its entirety.

### FIELD

This disclosure relates to apparatuses and methods of forming flexible glass laminates by electrostatically pinning together a flexible glass substrate and a laminate substrate with an adhesive.

### BACKGROUND

During manufacturing, glass can be formed as a continuous substrate web. The thickness of final glass product is determined when the glass cools and solidifies. Depending on the final use for the manufactured glass, the glass may be subject to certain thickness requirements. For example, glass used in applications such as electronic displays or touchscreens may benefit from a thickness of 0.3 millimeter or less. Customers for these applications require a consistent web surface that is free from particles, debris, damage or other surface non-uniformities. The thickness of a glass substrate web can directly affect the flexibility, surface sensitivity, air entrainment and consistency of the flexible glass web. For glass substrate webs with a thickness of 0.3 millimeter or less, the resulting increased flexibility of the glass substrate web enables roll to roll processing which creates a need for special handling procedures during and after the glass manufacturing process. Also, increased surface sensitivity may lead to an increased probability for cracks (relative to that for thicker substrate webs) and fractures on the surface of the glass substrate web. These conditions lead to difficulty in handling flexible glass substrate webs without causing breakage or otherwise damaging the flexible glass substrate. As a result, flexible glass substrate webs may be protected during processing, transport, or other manufacturing with the help of a laminate or through a lamination process. Current lamination technology is designed for metals, plastics, or paper webs and may use high pressure and heat that are potential causes of damage to flexible glass substrate webs. Accordingly, alternative handling and lamination measures for flexible glass substrate webs are needed to ensure the flexible glass substrate web is free of air bubbles and is not damaged prior to use in final applications.

### SUMMARY

Embodiments disclosed herein include apparatuses and methods of forming flexible glass laminates. The flexible glass laminates disclosed herein can be formed with a laminate substrate. As a non-limiting example, the flexible glass laminates can be formed by electrostatically pinning a flexible glass substrate and a laminate substrate together with an adhesive layer there between.

According to a first aspect, a method of forming a flexible glass laminate is provided that comprises:

charging a flexible glass substrate with an electrostatic charge;

charging a laminate substrate with an electrostatic charge that has a polarity opposite a polarity of the charge on the flexible glass substrate;

bringing the flexible glass substrate and the laminate substrate together, with an adhesive therebetween, thereby creating an adhesive bond and an electrostatic bond between the flexible glass substrate and the laminate substrate.

According to a second aspect, there is provided the method of aspect 1, further comprising treating the adhesive using a treatment device.

According to a third aspect, there is provided the method of aspect 1 or aspect 2, wherein the treatment device is a heating device.

According to a fourth aspect, there is provided the method of aspect 1 or aspect 2, wherein the treatment device is an ultraviolet light device.

According to a fifth aspect, there is provided the method of any one of aspects 1-4, wherein the electrostatic charge creates an electrostatic bond such that the shear force required to cause slip between the flexible glass substrate and laminate substrate is greater than the shear force required to cause slip between the flexible glass substrate and laminate substrate with the adhesive bond alone.

According to a sixth aspect, there is provided the method of any one of aspects 1-5, further comprising applying the adhesive to at least one of the laminate substrate and the flexible glass substrate before creating the electrostatic bond between the laminate substrate and the flexible glass substrate.

According to a seventh aspect, there is provided the method of any one of aspects 1-6, wherein the flexible glass substrate has a thickness of 0.3 millimeter or less.

According to a eighth aspect, there is provided the method of any one of aspects 1-7, further comprising using nip rollers to apply pressure to the laminate substrate and the flexible glass substrate.

According to a ninth aspect, a flexible glass laminate forming apparatus is provided that comprises:

a charge generator;

a first charging head connected to the charge generator capable of applying an electrostatic charge to a flexible glass substrate;

a second charging head connected to the charge generator capable of applying an opposite electrostatic charge to a laminate substrate, wherein the second charging head is positioned opposite the first charging head; and

an adhesive application device that applies adhesive to a surface of at least one of the laminate substrate and the flexible glass substrate to form an adhesive bond between the flexible glass substrate and laminate substrate.

According to a tenth aspect, there is provided the flexible glass laminate forming apparatus of aspect 9, further comprising a treatment device that is used to treat the adhesive.

According to a eleventh aspect, there is provided the flexible glass laminate forming apparatus of aspect 9 or aspect 10, wherein the treatment device is a heating device.

According to a twelfth aspect, there is provided the flexible glass laminate forming apparatus of aspect 9 or aspect 10, wherein the treatment device is an ultraviolet light device.

According to a thirteenth aspect, there is provided the flexible glass laminate forming apparatus of any one of aspects 9-12, further comprising an application nozzle that controls an amount and location of adhesive applied to the surface of at least one of the laminate substrate and the flexible glass substrate.

According to a fourteenth aspect, there is provided the flexible glass laminate forming apparatus of any one of aspects 9-13, further comprising nip rollers that apply pressure to the flexible glass laminate.

According to a fifteenth aspect, a flexible glass laminate is provided that comprises: a flexible glass substrate with an electrostatic charge;

a laminate substrate with an opposing electrostatic charge to form an electrostatic bond with the flexible glass substrate; and

an adhesive between the flexible glass substrate and the laminate substrate forming an adhesive bond between the flexible glass substrate and the laminate substrate.

According to a sixteenth aspect, there is provided the flexible glass laminate of aspect 15, wherein the flexible glass laminate is wound into a roll.

According to a seventeenth aspect, there is provided the flexible glass laminate of aspect 15, wherein the flexible glass laminate is a discrete sheet.

According to a eighteenth aspect, there is provided the flexible glass laminate of any one of aspects 15-17, wherein the laminate substrate comprises multiple strips of the laminate substrate positioned along a width of the flexible glass substrate.

According to a nineteenth aspect, there is provided the flexible glass laminate of any one of aspects 15-18, wherein the flexible glass substrate has a thickness of about 0.3 millimeter or less.

According to a twentieth aspect, there is provided the flexible glass laminate of any one of aspects 15-19, wherein the laminate substrate has a width less than the width of the flexible glass substrate.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description embodiments are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

FIG. 1 is a schematic illustration of a flexible glass laminate forming apparatus;

FIG. 2 illustrates a laminate substrate with adhesive applied to an interior surface;

FIG. 3 illustrates a close-up view of electrostatic pinning equipment included in the flexible glass laminate forming apparatus of FIG. 1;

FIG. 4 is a cross-sectional view of several layers of flexible glass substrate web and laminate substrate; and

FIG. 5 is a cross-sectional view of another embodiment of several layers of flexible glass substrate web and laminate substrate.

### DETAILED DESCRIPTION

Embodiments disclosed herein generally relate to forming flexible glass laminates using electrostatic pinning and an adhesive. A flexible glass substrate and a laminate substrate with an adhesive can be joined using electrostatic pinning, creating an intimate initial laminated glass surface. As will be discussed in greater detail below, the adhesive bond can increase in bond strength over time, with a longer term bond forming as the adhesive spreads between the flexible glass substrate and the laminate substrate.

FIG. 1 is a schematic drawing of an apparatus 100 for forming flexible glass laminates 102. The apparatus 100 applies an adhesive 110 to a laminate substrate web 120 using an application device 112 and subsequently electrostatically pins the laminate substrate web 120 together with a flexible glass substrate web 130 by applying opposing electrostatic charges to the laminate substrate web 120 and the flexible glass substrate web 130. The apparatus may also include rollers 121 for guiding the laminate substrate web 120 and apply tension thereto. After the laminate substrate web 120 and flexible glass substrate web 130 are electrostatically pinned together and also joined with an adhesive bond, the laminate substrate web 120 and flexible glass substrate web 130 may be wound into a roll 160. Alternatively, discrete sections of the laminate substrate web 120 and flexible glass substrate web 130 may be formed by the apparatus 100.

The flexible glass substrate web 130 may be supplied from an upstream process 161, for example a forming process or a conveyance process in connection with using or manipulating the flexible glass substrate web 130. The forming process may be a down draw, slot draw, fusion draw, float, or other similar process. For example, a fusion process (e.g. a downdraw process) forms high quality thin glass sheets that can be used in a variety of devices, for example flat panel displays. Glass sheets or webs formed in a fusion process have surfaces with superior flatness and smoothness when compared to glass sheets formed by other methods. The fusion process is described in U.S. patent Ser. Nos. 3,338,696 and 3,682,609. The flexible glass substrate web 130 may be “ultra-thin” having a thickness of about 0.3 mm or less, including, but not limited to, thicknesses of, for example, about 0.01-0.05 mm, about 0.05-0.1 mm, about 0.1-0.15 mm, about 0.15-0.3 mm, for example 0.3, 0.29, 0.28, 0.27, 0.26, 0.25, 0.24, 0.23, 0.22, 0.21, 0.2, 0.19, 0.18, 0.17, 0.16, 0.15, 0.14, 0.13, 0.12, 0.11, 0.1, 0.09, 0.08, 0.07, 0.06, and 0.05 mm.

The conveyance process may include conveying the flexible glass substrate web 130 through a manufacturing apparatus or processing the flexible glass substrate web 130. Further examples of processes in which the flexible glass substrate web 130 may be conveyed include any step subsequent to the formation of the glass, for example grinding, polishing, cleaning, the formation of thin film devices on the glass, cutting, splicing, rolling from another roll, etching processes, or lamination to other films or structures.

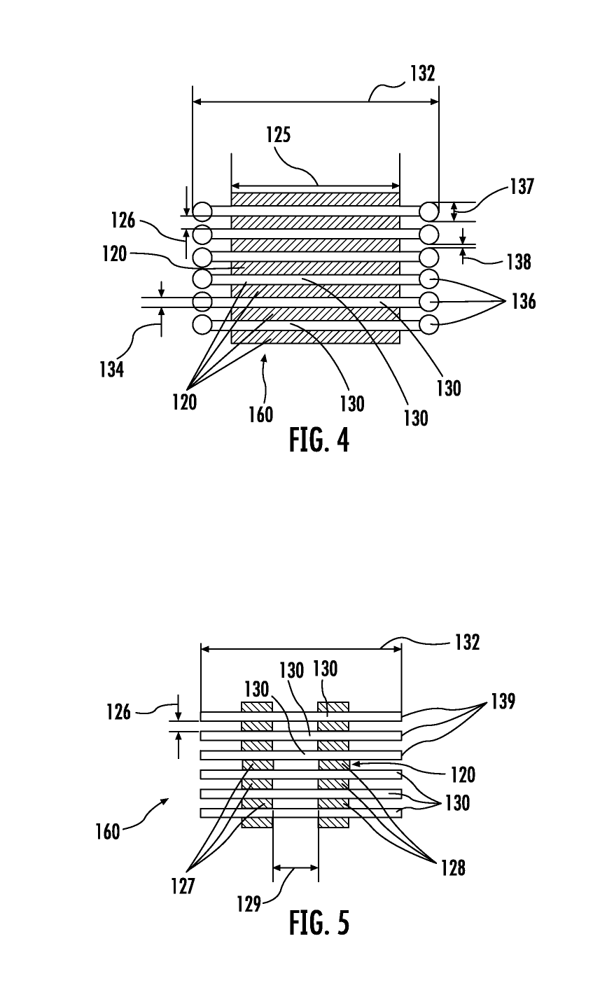

The laminate substrate web 120 may be supplied in a roll 122 having a central longitudinal axis 123. The roll 122 may rotate in the direction of arrow 124 as laminate substrate web 120 is pulled into roll 160. The laminate substrate web 120 has a width 125 and a thickness 126 (shown in FIG. 4), which may be considered when determining the amount of electrostatic charge to be applied to the laminate substrate web 120, as discussed below. The width 125 may be greater than, less than, or equal to about the width of the flexible glass substrate web 130. Further, the laminate substrate web 120 may be formed from materials for example polymers, polyethylene foam, corrugated paper material, or polyvinyl material with an embossed or textured surface. The laminate substrate web 120 may be thickness compliant and compressed. In other embodiments, the laminate substrate web 120 may not be thickness compliant and may not be compressed. In some embodiments, the laminate substrate web 120 may come with adhesive pre-applied, in which case the apparatus 100 may not include the application device 112 for adhesive 110.

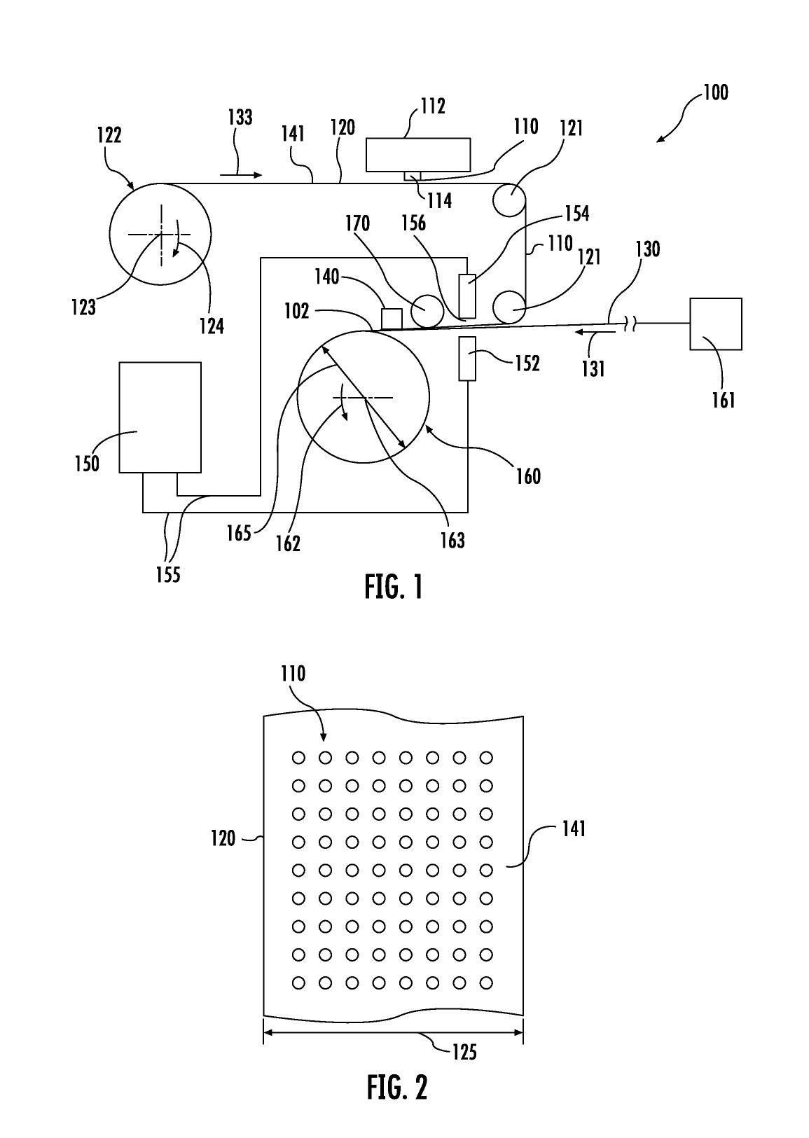

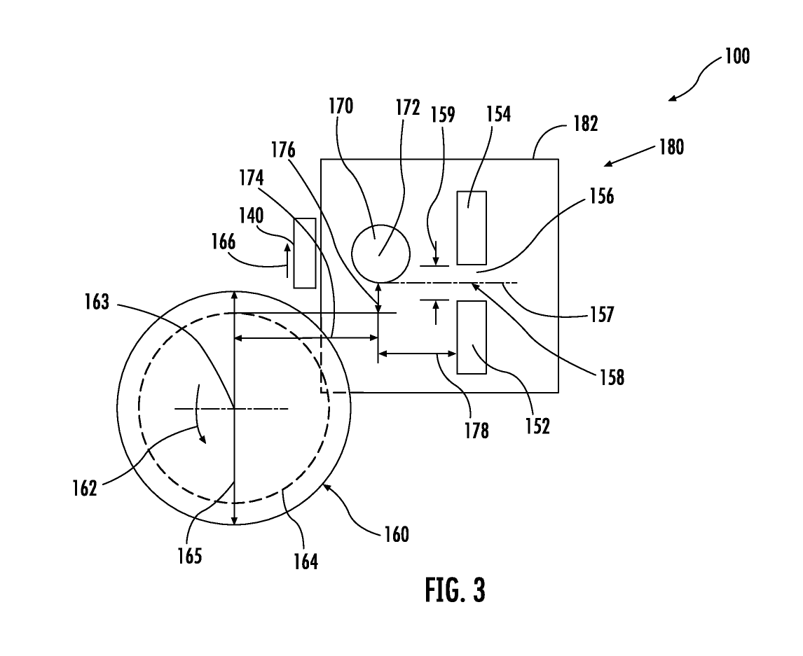

The apparatus 100 includes a charge generator 150 or other device to create electrostatic charges and may include a treatment device 140 for treating the adhesive 110. In some embodiments, the flexible glass substrate web 130 is fed from the upstream process 161 along direction 131, past a first charging head 152 and toward the roll 160, which rotates in a direction of arrow 162. At or about the same time the flexible glass substrate web 130 is fed toward the roll 160, the laminate substrate web 120 is unwound from the roll 122 rotating in direction of arrow 124 and is fed along direction 133. The laminate substrate web 120 is positioned relative to the roll 160 and to a second charging head 154 by rollers 121. In one embodiment, before reaching the second charging head 154, the laminate substrate web 120 passes under the application device 112, where adhesive 110 is applied to the laminate substrate web 120. The adhesive 110 is applied via an application nozzle 114, and can be applied in various patterns, amounts or densities, for example as a dot pattern (shown in FIG. 2) or any other suitable pattern, for example stripes, and zig-zags. In some embodiments, the laminate substrate web 120 and the flexible glass substrate web 130 may both be fed directly into the apparatus 100 as discrete sheets, rather than from rolls of material.

Electrostatic charges are applied to the laminate substrate web 120 and flexible glass substrate web 130 by the charge generator 150, which is coupled to the first charging head 152 and the second charging head 154 via connections 155. The first charging head 152 is placed near the flexible glass substrate web 130 and may apply a negative charge to the flexible glass substrate web 130, and the second charging head 154 is placed near the laminate substrate web 120 and may apply a positive charge to the laminate substrate web 120, or vice versa. The charging heads 152, 154 can add charge to the laminate substrate web 120 and flexible glass substrate web 130 rather than polarize the existing charges in the laminate substrate web 120 and flexible glass substrate web 130. The amount of charge to be added so as to pin the flexible glass substrate web 130 with the laminate substrate web 120 can depend upon, among other things, the thickness 134 of the flexible glass substrate web 130, and the characteristics of the laminate substrate web 120, for example its thickness 126 (shown in FIG. 4) or the type of material of which it is made. However, the electrostatic bond created may be of a value such that the shear force required to cause slip between the laminate substrate web 120 and flexible glass substrate web 130 is greater than (e.g., about 2 times greater or more, for example, about 5 times greater or more, about 10 times greater or more) the shear force required to cause slip between the laminate substrate web 120 and flexible glass substrate web 130 without electrostatically pinning the substrates together or with adhesive alone. The charging heads 152, 154 may either extend across the full width of overlap between the laminate substrate web 120 and flexible glass substrate web 130, extend across only a portion of the widths 125, 132, or may extend across various portions of the widths 125, 132 so as to apply the charges in separate continuous strips along the length of the laminate substrate web 120 and flexible glass substrate web 130. Furthermore, the charging heads 152, 154 may either provide a region of continuous charge along the lengths of the laminate substrate web 120 and flexible glass substrate web 130, or may be energized intermittently so that areas of charge are applied along the length of the laminate substrate web 120 and flexible glass substrate web 130 and intermittent sections of both are pinned together. After the laminate substrate web 120 and flexible glass substrate web 130 pass the charging heads 152, 154, an initial intimate laminated surface is created by the opposing electrostatic charges. The opposing electrostatic charges create an electrostatic bond between the laminate substrate web 120 and the flexible glass substrate web 130. The electrostatic bond in turn creates a nip force that initiates contact between the adhesive 110 and the opposing substrate web, as discussed below.

In some embodiments, the apparatus 100 may include a roller 170, or more than one roller 170 so as to form a nip. In one embodiment, the roller 170 makes contact with the laminate substrate web 120 and applies pressure to enhance the electrostatic and adhesive bonds between the laminate substrate web 120 and flexible glass substrate web 130. The treatment device 140 may be positioned downstream from the roller 170 in the apparatus 100. The treatment device 140 can be any device used for treating the adhesive 110 between the laminate substrate web 120 and flexible glass substrate web 130, for example a heating or other temperature control device or an ultraviolet light device that provides an ultraviolet light in order to activate the adhesive 110 or enhance the bonds between the laminate substrate web 120 and flexible glass substrate web 130. The electrostatically pinned and adhesively bonded laminate substrate web 120 and flexible glass substrate web 130 may then be rolled together into the roll 160, wherein successive wraps of laminate substrate web 120 and flexible glass substrate web 130 are also electrostatically pinned to one another to keep the successive wraps from sliding relative to one another during transportation or storage of the roll 160. Alternatively, discrete sheets of electrostatically pinned laminate substrate web 120 and flexible glass substrate web 130 may then be segmented and stacked, where successive layers in the stack are also electrostatically pinned to one another.

Referring to FIGS. 1 and 2, the application device 112 applies adhesive 110 to an interior surface 141 of the laminate substrate web 120, before the laminate substrate web 120 is electrostatically pinned to the flexible glass substrate web 130. A close-up of the interior surface 141 is shown in FIG. 2. The interior surface 141 is interior in that it the surface to be positioned on an interior of the flexible glass laminate 102 and is the surface that comes in contact with the flexible glass substrate web 130. The application device 112 has the application nozzle 114 that assists in controlling the amount of adhesive 110 dispensed as the laminate substrate web 120 passes underneath the application device 112. The application device 112, through the application nozzle 114, can apply various amounts and densities of the adhesive depending on the configuration. For example, the application nozzle 114 can be configured as a line or array of nozzles so as to apply the adhesive 110 in a dot pattern as shown in FIG. 2, or may otherwise be moved or controlled so as to apply adhesive in a stripe, zigzag, or other pattern, including randomly. The volume of adhesive 110 applied can also be adjusted by configuring the application nozzle 114 with larger or smaller orifices, or varying other fluid application parameters for delivering adhesive to the nozzle 114, accordingly.

The adhesive 110 can be different types of adhesives, such as contact adhesives, thermal adhesives, synthetic adhesives, and the like. The bonding chemistry and pattern in which the adhesive 110 is applied can affect the adhesive bond strength and amount of adhesive 110 applied to the laminate substrate web 120. Also, the apparatus 100 may be differently configured depending upon the type of adhesive 110 applied. For example, a thermal treatment device 140 may be used when applying a thermally activated adhesive, or an ultraviolet treatment device 140 may be used when applying an ultraviolet activated adhesive. Other adhesives, for example a pressure sensitive adhesive, synthetic adhesive, or a contact adhesive can also be used with the apparatus 100. As the adhesive 110 is forced into contact with the flexible glass substrate web 130 and the laminate substrate web 120 via the action of the electrostatic forces, an adhesive bond is formed. In some embodiments, wherein the adhesive does not exist over the entire area of overlap between the flexible glass substrate web 130 and the laminate substrate web 120, the strength of the adhesive bond increases over time as the adhesive 110 spreads. This is due to the electrostatic force bringing the flexible glass substrate web 130 together with the laminate substrate web 120 in order to cover a larger surface area between the laminate substrate web 120 and the flexible glass substrate web 130. Additionally, as the electrostatic forces bring together the flexible glass substrate web 130 and the laminate substrate web 120, air entrainment may be reduced or prevented and air may be excluded and/or pushed from between the laminate substrate web 120 and the flexible glass substrate web 130 as the adhesive 110 spreads via the force of the webs coming together. The use of electrostatic force may remove the need for other external pressures to be applied by nip rollers, for example. In some embodiments, the adhesive 110 may be applied to the flexible glass substrate web 130 or both the flexible glass substrate web 130 and the laminate substrate web 120.

Referring to FIG. 3, as noted above, the flexible glass laminate 102 may be wound onto the roll 160. The roll 160 may include a core 164, with a central longitudinal axis 163 about which the core 164 rotates in the direction of arrow 162. As illustrated in FIG. 4, the roll 160 includes laminate substrate web 120 and flexible glass substrate web 130 wound in alternate layers. In FIG. 3, the charging heads 152, 154 may be part of an electrostatic field applying device 180 that includes a frame 182. The charging heads 152,154 may also be standalone and attached directly to the apparatus 100. The treatment device 140 for the adhesive 110 may be placed downstream from the charging heads 152, 154, or if the roller 170 is included, downstream from both the charging heads 152, 154 and the roller 170. The charging heads 152, 154 are positioned so that each charging head 152, 154 is separated from the other by a gap 156 having a center 158 and distance 159. The distance 159 may range from 1 inch to 4 inches, for example. The distance 159 is chosen so that the laminate substrate web 120 and flexible glass substrate web 130 pass through in close proximity to one another and are electrostatically pinned to one another shortly after they are charged by respective charging heads 152, 154. This reduces the time for foreign particles to be attracted to either the flexible glass substrate web 130 or laminate substrate web 120. Particles on the surface of flexible glass substrate web 130 may lead to damage to the structures applied to the flexible glass substrate web 130, or damage to the surface of the flexible glass substrate web 130. In other embodiments, instead of rolling the laminate substrate web 120 and flexible glass substrate web 130 together, discrete sheets may be formed and stacked.

Still referring to the embodiment illustrated in FIG. 3, a conveying path 157 extends through the center 158 of the gap 156 and along a tangent to the outside diameter of the roller 170. The roller 170 can be mounted to the frame 182 and is located downstream of the charging heads 152, 154 by a distance 178. The distance 178 is chosen so that the roller 170 is close to the charging heads 152,154, but not within the field of charge imparted by them. The laminate substrate web 120 and flexible glass substrate web 130 enter the gap 156 on either side of the center 158, and by the time they reach the roller 170, they are pinned to one another forming the flexible glass laminate 102 and travel along the conveying path 157. The roller 170, or nip rollers in the same location, may be used together with the electrostatic pinning in the event that there is desired a normal force greater than that formed by electrostatic pinning alone. Such may be the case when certain pressure sensitive adhesives are used, for example. In this situation, the electrostatic pinning may form an initial alignment and pinning of the webs, and the pressure sensitive adhesive may be more fully activated by the nip rollers. The roller 170 may also be located so that its center 172 is disposed at a lateral distance 174 from the longitudinal axis 163 of the roll 160, and so that its outside diameter is located at a distance 176 from the outside diameter of the core 164. Distance 176 is also the distance from the conveyance path 157 and the bottom of the treatment device 140 to the outside diameter of the core 164. By appropriately choosing distance 176, relative to distance 159, and the diameter of roller 170 and distance 174, the laminate substrate web 120 and flexible glass substrate web 130 may be continuously conveyed through the gap 156 without touching the charging heads 152, 154 from the time that they are first wrapped around core 164 and thereafter as the diameter 165 of the roll 160 grows in the direction 166 with each successive wrap of laminate substrate web 120 and flexible glass substrate web 130 around the core 164. If the distance 176 is larger than the distance 159, the flexible glass substrate web 130 will contact the charging head 152 on the initial wrap around core 164. As distance 174 becomes smaller, there is less room to accommodate the growing diameter 165 of the roll 160, which then limits the amount of flexible glass substrate web 130 that may be disposed in the roll 160. If the distance 174 is large enough, the diameter 165 may grow upward beyond the conveyance path 157, yet the laminate substrate web 120 and flexible glass substrate web 130 will be appropriately maintained relative to the conveyance path 157 by the laminate substrate web 120 contacting the roller 170. As the diameter 165 grows, the laminate substrate web 120 and flexible glass substrate web 130 will bend further and further around roller 70. Accordingly, the diameter of the roller 170 should be large enough so as to avoid breakage in the flexible glass substrate web 130.

FIG. 4 illustrates a cross-sectional view of several layers of the flexible glass substrate web 130 with width 132 and thickness 134 and four layers of the laminate substrate web 120 with width 125 and thickness 126. In some embodiments, FIG. 4 can be a cross-section of the roll 160, or in other embodiments, a cross-section of a stack of discrete segmented sheets of the flexible glass substrate web 130 and the laminate substrate web 120. In the embodiment with the roll 160 illustrated in FIG. 2, the diameter 165 of the roll 160 grows as successive layers of laminate substrate web 120 and flexible glass substrate web 130 are wound. The flexible glass substrate web 130 is shown as including edge beads 136 having a thickness 137. The thickness 126 is chosen so that when the laminate substrate web 120 is subject to a pressure between the layers in the roll, the laminate substrate web 120 maintains a gap 138 between adjacent edge beads 136, thereby allowing the flexible glass substrate web 130 to be wound into the roll 160 or stacked without damage from the edge beads 136 contacting one another. As shown, the width 125 of the laminate substrate web 120 may be less than the width 132 of the flexible glass substrate web 130. In other embodiments, the width 125 of the laminate substrate web 120 may be greater than or equal to the width 132 of the flexible glass substrate web 130.

FIG. 5 shows another embodiment of several layers of flexible glass substrate web 130 and laminate substrate web 120 after they have been electrostatically pinned together and adhesively bonded. In this embodiment, the flexible glass substrate web 130 does not have beads and may be used with one or more strips of the laminate substrate web 120. The laminate substrate web 120 can be formed as a first strip 127 and a second strip 128 separated by a distance 129. Although only two strips 127, 128 of laminate substrate web 120 are shown, any number of strips may be used. The laminate substrate web 120 includes a thickness 126 and the flexible glass substrate web 130 includes edges 139. In this embodiment, the charging heads 152, 154 would be configured to apply charge only across width 132 between the flexible glass substrate web 130 and the strips 127, 128 of laminate substrate web 120.

The flexible glass substrate web 130 forming process can produce variations in the thickness 134 of the flexible glass substrate web 130 across its width 132. Also, during a standard lamination process, the flexible glass substrate web 130 can crack or develop other surface defects. When the flexible glass web is less than about 0.3 millimeter thick, the propensity for developing cracks may increase. These cracks and surface defects can propagate and reduce yields. By using a process of electrostatically pinning the flexible glass substrate web 130 to a laminate substrate web 120 that has adhesive 110 any cracks that occur may be prevented from further propagating because the flexible glass substrate web 130 is laminated to the laminate substrate web 120 via electrostatic and adhesive bonds. By applying electrostatic charges to the laminate substrate web 120 and flexible glass substrate web 130, an attraction between successive layers of laminate substrate web 120 and flexible glass substrate web 130 is developed, which can allow straight side walls to be formed and increase stability of the stack or roll of electrostatically pinned laminate and glass. The electrostatically pinned laminate with adhesive also provides a functional surface that can be used for lens patterns or textures and also serves as a protective film during set up for processing or conveyance. The electrostatic charge may be removed by application of a de-ionizing field. The flexible glass substrate web 130 and the laminate substrate web 120 may remain bonded together by the adhesive 110, even after removal of the electrostatic charge. Adhesive chemistry can be used to reverse bonding of the adhesive 110 to the glass surface to release the flexible glass substrate web 130 from the laminate substrate web 120.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

For example, although the adhesive was described as being applied to the laminate substrate web 120, it may alternatively, or in addition, be applied to the glass substrate web 130. It may be advantageous to apply the adhesive to both the laminate substrate web 120 and the glass substrate web 130 in the event that the adhesive is a two-part adhesive and, in such case, one or both parts of the adhesive may be applied to a respective web and rolled for later combination with the corresponding web and adhesive part.

What is claimed is:

1. A method of forming a flexible glass laminate comprising:
charging a flexible glass substrate with an electrostatic charge;
charging a laminate substrate with an electrostatic charge that has a polarity opposite a polarity of the charge on the flexible glass substrate;
bringing the flexible glass substrate and the laminate substrate together, with an adhesive therebetween, thereby creating an adhesive bond and an electrostatic bond between the flexible glass substrate and the laminate substrate.

2. The method of claim 1 further comprising treating the adhesive using a treatment device.

3. The method of claim 2, wherein the treatment device is a heating device or an ultraviolet light device.

4. The method of claim 1, wherein the electrostatic charge creates an electrostatic bond such that the shear force required to cause slip between the flexible glass substrate and laminate substrate is greater than the shear force required to cause slip between the flexible glass substrate and laminate substrate with the adhesive bond alone.

5. The method of claim 1 further comprising applying the adhesive to at least one of the laminate substrate and the flexible glass substrate before creating the electrostatic bond between the laminate substrate and the flexible glass substrate.

6. The method of claim 1, wherein the flexible glass substrate has a thickness of 0.3 millimeter or less.

7. The method of claim 1 further comprising using nip rollers to apply pressure to the laminate substrate and the flexible glass substrate.

8. A flexible glass laminate forming apparatus comprising:
a charge generator;
a first charging head connected to the charge generator capable of applying an electrostatic charge to a flexible glass substrate;
a second charging head connected to the charge generator capable of applying an opposite electrostatic charge to a laminate substrate, wherein the second charging head is positioned opposite the first charging head; and
an adhesive application device for applying adhesive to a surface of at least one of the laminate substrate and the flexible glass substrate.

9. The apparatus of claim 8 further comprising a treatment device that is used to treat the adhesive.

10. The apparatus of claim 9, wherein the treatment device is a heating device or an ultraviolet light device.

11. The apparatus of claim 8 further comprising an application nozzle for applying adhesive to the surface of at least one of the laminate substrate and the flexible glass substrate.

12. The apparatus of claim 8 further comprising nip rollers for applying pressure to the flexible glass laminate.

13. A flexible glass laminate comprising:
a flexible glass substrate;
a laminate substrate
an electrostatic bond between the flexible glass substrate and the laminate substrate; and
an adhesive between the flexible glass substrate and the laminate substrate forming an adhesive bond between the flexible glass substrate and the laminate substrate.

14. The apparatus of claim 13, wherein the laminate substrate comprises multiple strips of the laminate substrate positioned along a width of the flexible glass substrate.

15. The apparatus of claim 13, wherein the flexible glass substrate has a thickness of 0.3 millimeter or less.
